(19) United States
(12) Patent Application Publication
(10) Pub. No.: US 2010/0134380 A1
(43) Pub. Date: Jun. 3, 2010

(54) ANTENNA DEVICE AND METHOD OF MANUFACTURING THE SAME

(75) Inventors: Chao-Hui Yu, Taipei Hsien (TW); Hung-Jen Chen, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/325,557

(22) Filed: Dec. 1, 2008

(51) Int. Cl. H01Q 1/40; H01P 11/00

(52) U.S. Cl. 343/873; 29/600

(57) ABSTRACT

An antenna device disposed in an electronic device which has a housing and a control circuit includes a metallic antenna, a carrier film and a plastic base. The metallic antenna is electrically connected with the control circuit for receiving and sending a signal. The carrier film bears the metallic antenna on one surface thereof. The plastic base is integrated with the assembly of the metallic antenna and the carrier film with the metallic antenna and sandwiched between the carrier film and the plastic base. The antenna device prevents the antenna from the wear and tear normally encountered during everyday use.

### BACKGROUND OF THE INVENTION

1. Field of the Invention

The present invention relates to an antenna, and particularly to an internal antenna for use in telecommunication equipment and a method of manufacturing the same.

2. The Related Art

All mobile telecommunication equipment, such as hand-held electronic devices, requires at least one antenna in order to be able to receive and/or send radio signals. In the hand-held electronic device, the antenna can be external or internal.

However, as the external antenna is disposed externally to the main body of the electronic device and usually projects from a top surface of the main body, which is prone to damage and can reduce the aesthetic appeal of the electronic device. And as the internal antenna is disposed on a printed circuit board in the electronic device, the electronic device tends to be relatively bulky and requires extra steps in the assembly process, which ultimately increases the cost of the electronic device and offers more opportunity for error to occur.

### SUMMARY OF THE INVENTION

Accordingly, an object of the present invention is to provide an antenna device. The antenna device disposed in an electronic device which has a housing and a control circuit includes a metallic antenna, a carrier film and a plastic base. The antenna is electrically connected with the control circuit for receiving and sending a signal. The carrier film bears the antenna on one surface thereof. The plastic base is integrated with the assembly of the antenna and the carrier film with the antenna being sandwiched between the carrier film and the plastic base.

In a preferred embodiment, the plastic base of the antenna device servers as the housing or a part of the housing of the electronic device.

Another object of the invention is to provide a method of manufacturing the antenna device. The method includes the following steps: fixing an antenna on one surface of a carrier film; inserting the assembly of the carrier film and the antenna into a mold; forming a plastic base integrated with the assembly of the antenna and the carrier film by injecting molding material into the mold.

The antenna is sandwiched between the plastic base and the carrier film, which prevents the antenna from the wear and tear normally encountered during everyday use. In addition, the antenna is formed on the plastic base, which can serve as the housing or a part of the housing of the electronic device. So the occupation of the antenna device inside the electronic device can be decreased, which is of benefit for the microminiaturization of the electronic device and enhancing the artistry of the electronic device.

### BRIEF DESCRIPTION OF THE DRAWINGS

The present invention will be apparent to those skilled in the art by reading the following description of a preferred embodiment thereof, with reference to the attached drawings, in which:

FIG. 1 is a cross-section view of an antenna device according to the present invention; and

FIGS. 2-5 show the stages in the process of manufacturing the antenna device in FIG. 1.

### DETAILED DESCRIPTION OF THE PREFERRED EMBODIMENT

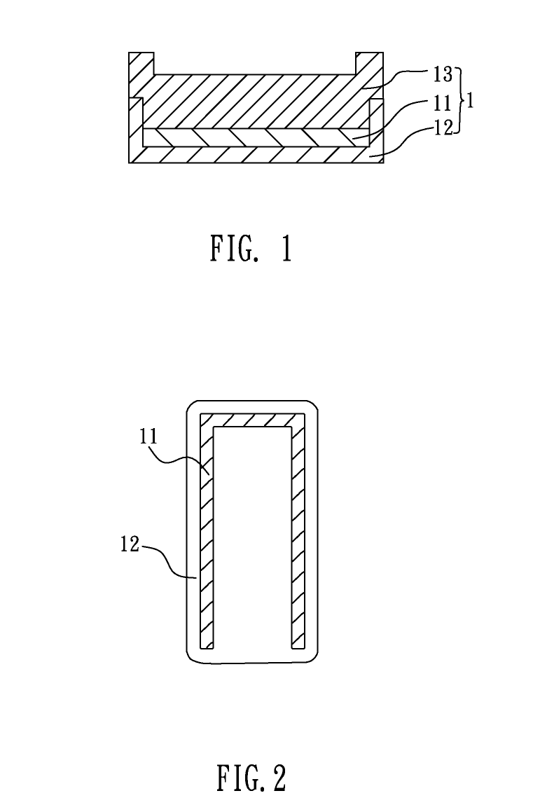

Referring to FIG. 1, a preferred embodiment of an antenna device 1 according to the present invention is shown. The antenna device 1 is disposed in a housing of an electronic device for receiving and/or sending radio signals.

The antenna device 1 includes an antenna 11 of a metallic material, a carrier film 12 for bearing the antenna 11, and a plastic base 13. The antenna 11 is sandwiched between the carrier film 12 and the plastic base 13. A plurality of holes or grooves (not shown) are reserved in the plastic base 13, through which the antenna 11 is electrically connected to a control circuit in the electronic device. The plastic base 13 can serve as the housing or a part of the housing of the electronic device.

FIGS. 2-5 illustrates a method of manufacturing the antenna device 1 according to the present invention.

FIG. 2 shows a combination of the antenna 11 and the carrier film 12. The carrier film 12 can be transparent or opaque. For artistic purpose, a text and a graphic design are pre-printed on one surface of the carrier film 12.

The design of the antenna 11 will vary markedly depending on the frequency and operating characteristics of the electronic device. The antenna 11 can be flexible metal or conductive graphite. In this embodiment, the antenna 11 is made of a conductive copper foil, which can be appropriate expanded and bent to attach to the plastic base 13. The antenna 11 is glued to one surface of the carrier film 12 by viscose.

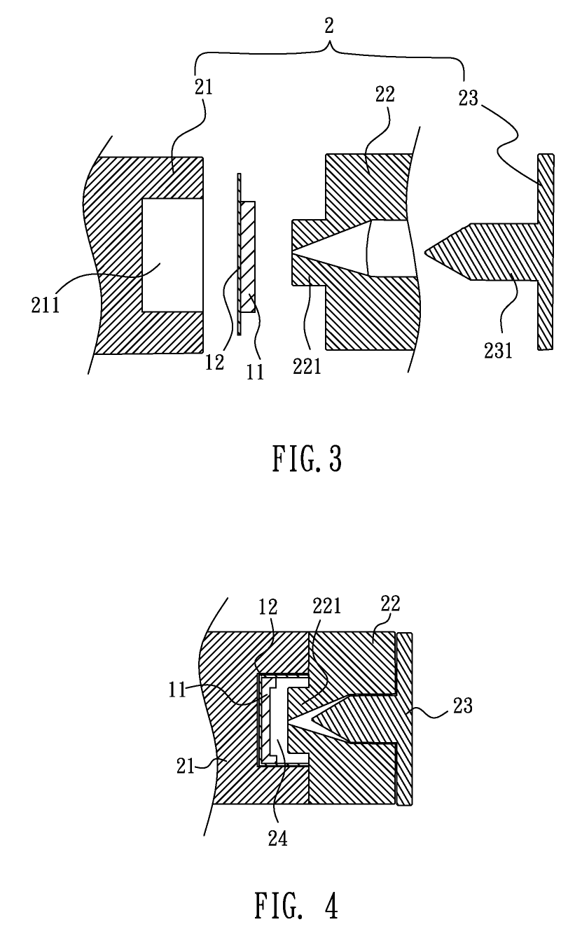

FIGS. 3-5 illustrates the process of fixing the carrier film 12 bearing the antenna 11 on the plastic base 13 by In-molding Label (IML).

Please refer to FIG. 3, after the antenna 11 is glued on the carrier film 12, the combination of the antenna 11 and the carrier film 12 is arranged in a mold 2. The mold 2 includes a first part 21, a second part 22 and an injection part 23. The first part 21 has a molding cavity 211 and the second part 22 has an engaging portion 221 corresponding to the molding cavity 211. When the first part 21 engages with the second part 22, a space 24 is formed between the molding cavity 211 and the engaging portion 221. The shape of the space 24 determines the shape of the plastic base 13 molded by the mold 2. The injection part 23 is connected to a reservoir of molding material via a nozzle 231.

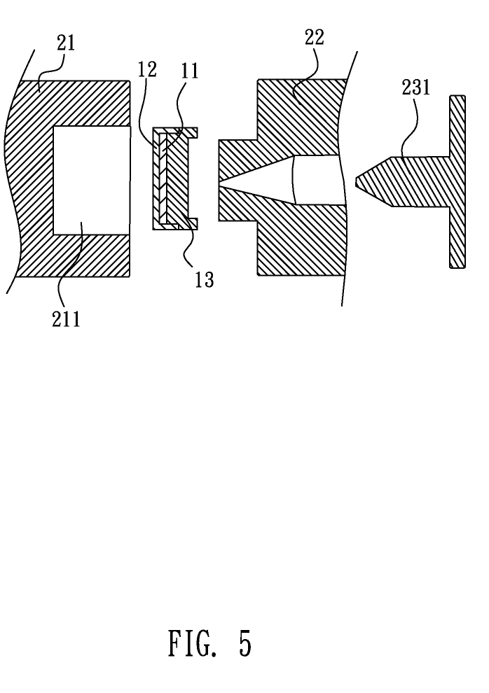

FIG. 4 and FIG. 5 show how the combination of the antenna 11 and the carrier film 12 is placed into the mold 2 and the plastic base 13 is molded.

Firstly, the combination of the antenna 11 and the carrier film 12 is attached to the inner surface of the molding cavity 211 of the first part 21 of the mold 2 smoothly to prevent the carrier film 12 from puckering in the molding process. The carrier film 12 is inserted into the first part 21 of the mold 2 in manner that the side of the carrier film 12 opposite the side bearing the antenna 11 faces the inner surface of the molding cavity 211, through which the antenna 11 will come into direct contact with the plastic base 13.

After the combination of the antenna 11 and the carrier film 12 is arranged in the mold 2, all components of the mold 2 are securely fastened together. The molten molding material is injected into the space 24 via the nozzle 231 of the injection part 23. When cooled, the mold 2 is opened, as shown in FIG. 5, the carrier film 12 is molded as an integral part of the plastic base 13 and the antenna 11 is sandwiched between the carrier film 12 and the plastic base 13.

During the molding process described above, the antenna 11 can be disposed on an external side or an internal side of the plastic base 13. And before the process, proper structures can be disposed in the space 24 of the mold 2 to make the holes or grooves be reserved in the molded plastic base 13, through which the antenna 11 is electrically connected to the control circuit in the electronic device.

As described above, the antenna 11 is sandwiched between the plastic base 13 and the carrier film 12, which prevents the antenna 11 from the wear and tear normally encountered during everyday use. In addition, the antenna 11 is formed on the plastic base 13, which can serve as the housing or a part of the housing of the electronic device. So the occupation of the antenna device 1 inside the electronic device can be decreased, which is benefic for the microminiaturization of the electronic device and enhancing the aesthetic of the electronic device.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An antenna device adapted for an electronic device which has a housing and a control circuit, the antenna device comprising:
a antenna for being electrically connected with the control circuit;
a carrier film bearing the antenna on one surface thereof; and
a plastic base integrated with the assembly of the antenna and the carrier film with the antenna being sandwiched between the carrier film and the plastic base.

2. The antenna device as claimed in claim 1, wherein the plastic base serves as the housing or a part of the housing of the electronic device.

3. The antenna device as claimed in claim 1, wherein the antenna is made of a conductive copper foil.

4. The antenna device as claimed in claim 3, wherein the antenna is fixed on the carrier film by viscose.

5. The antenna device as claimed in claim 4, wherein the other surface of the carrier film is pre-printed with a text or a graphic design.

6. The antenna device as claimed in claim 1, wherein the antenna is made of metallic material.

7. A method of manufacturing an antenna device comprising the steps of:
fixing an antenna on one surface of a carrier film;
inserting the assembly of the carrier film and the antenna into a mold; and
forming a plastic base integrated with the assembly of the antenna and the carrier film by injecting molding material into the mold.
